(19) United States
(12) Patent Application Publication
(10) Pub. No.: US 2007/0095171 A1
(43) Pub. Date: May 3, 2007

(54) Bottle opener

(76) Inventor: Adam C. Gold, New York, NY (US)

Correspondence Address: Raymond Sun, 12420 Woodhall Way, Tustin, CA, 92782, US

(21) Appl. No.: 11/521,164

(22) Filed: Sep. 14, 2006

Related U.S. Application Data
(60) Provisional application No. 60/732,462, filed on Nov. 1, 2005.

(51) Int. Cl. B67B 7/16; B67B 7/44

(52) U.S. Cl. 81/3.55; 81/3.09

(57) ABSTRACT

A bottle opener has a housing that includes a speaker, a display, and an engaging opening. The engaging opening has a detection mechanism that detects the removal of a cap of a bottle. A processor is coupled to the detection mechanism and the display, the processor decreasing the count by one when the detection mechanism detects the removal of a cap.

### BACKGROUND OF THE INVENTION

1. Related Cases

This application is based on Provisional Application No. 60/732,462, filed Nov. 1, 2005, entitled “Bottle Opener”.

2. Field of the Invention

The present invention relates to a bottle opener, and in particular, to a bottle opener which opens bottles and counts the number of bottles opened.

3. Description of the Prior Art

There are a number of situations where it is desirable to count the number of bottles that have been opened. There are a number of existing bottle openers that have counters. Examples include U.S. Pat. Nos. 4,607,543, 3,336,665 and 2,984,131.

### SUMMARY OF THE INVENTION

It is an object of the present invention to provide a bottle opener that can effectively count the number of bottles opened.

It is another object of the present invention to provide a bottle opener that plays a song after a bottle has been opened.

In order to accomplish the above-described and other objects of the present invention, the present invention provides a bottle opener having a housing that includes a display, and an engaging opening. The engaging opening has a detection mechanism that detects the removal of a cap of a bottle. A processor is coupled to the detection mechanism and the display, the processor decreasing the count by one when the detection mechanism detects the removal of a cap.

### BRIEF DESCRIPTION OF THE DRAWINGS

FIG. 1 is a perspective view of a bottle opener according to one embodiment of the present invention.

FIG. 2 illustrates the electronics inside the bottle opener of FIG. 1.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

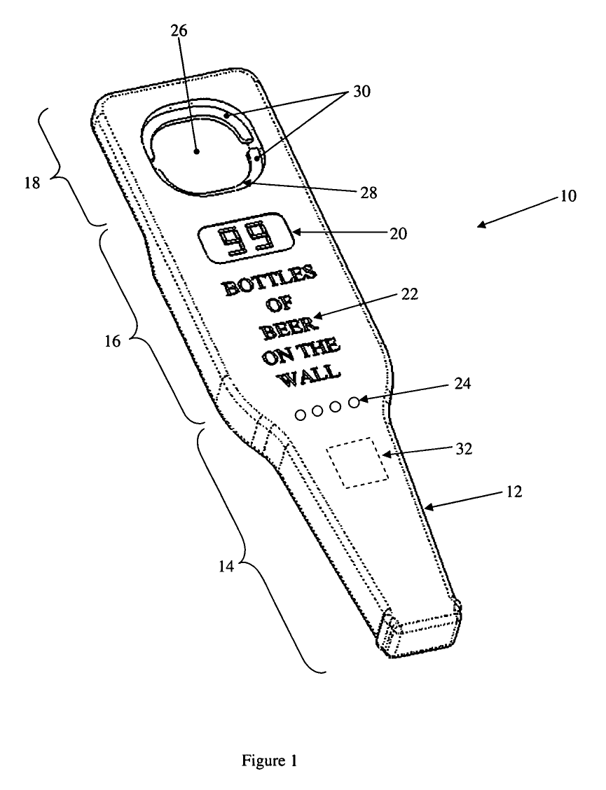

FIG. 1 illustrates a bottle opener 10 according to the present invention. The bottle opener 10 has a generally planar housing 12 that can be shaped like a beer bottle. The housing 12 has a handle section 14, a display section 16, and an opening section 18. The handle section 14 is adapted for the user to wrap his/her fingers around to grip the bottle opener 10 during use. The display section 16 includes a digital display 20 that displays a digital number or count. In addition, an illustration 22 can be provided on the outer surface of the housing 12. The illustration 22 can be a word, a phrase, a slogan, a logo, or a drawing. In the present embodiment, the illustration is the phrase “______ bottles of beer on the wall” which represents the name of the song or audio output being broadcast when a bottle is opened (as explained below). A speaker 24 can also be provided in the housing 12, and can be positioned anywhere in the sections 14 or 16. A counter-reset button 32 can be provided in either of the sections 14 or 16.

A bottle engaging opening 26 is provided in the opening section 18. The opening 26 extends through the thickness of the entire housing 12, and has an opening edge 28 which is adapted to engage the bottom edges of a bottle cap. A plurality of metal contacts 30 are provided in spaced-apart relation along the opening edge 28.

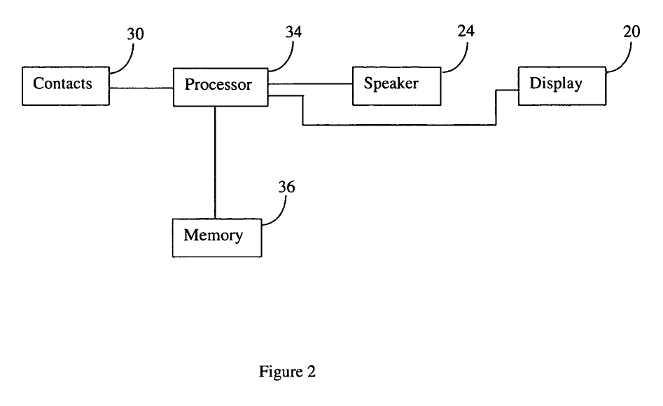

FIG. 2 illustrates the electronics of the bottle opener 10, which includes a processor 34 coupled to the contacts 30. In addition, the speaker 24 and the display 20 (which can be a conventional LCD display) are coupled to the processor 34. A memory 36 (e.g., a RAM) can be coupled to the processor 34. The memory 36 is adapted to store the count that is being displayed in the display 20, and to store the song(s) and audio output to be broadcast at the speaker 24.

In use, the display 20 displays a maximum count, such as 100, prior to use. When a user desires to open a bottle, the user inserts the bottle and its metallic cap through the opening 26, and pulls on the housing 12 to remove the cap from the bottle. This causes the metallic bottle cap to contact the contacts 30, thereby creating a closed electrical circuit to cause the processor 34 to recognize that another bottle has been opened. The processor 34 then decreases the count at the display 20 by an increment of one. At the same time, the processor 34 causes a selected song or audio output to be broadcast at the speaker 24. For example, if the illustration is the phrase “______ bottles of beer on the wall”, then the song can be the tune for “99 bottles of beer”. When the count gets to zero, special celebratory visual and audio feedback can be provided at the display 20 and the speaker 24.

While the description above refers to particular embodiments of the present invention, it will be understood that many modifications may be made without departing from the spirit thereof. The accompanying claims are intended to cover such modifications as would fall within the true scope and spirit of the present invention. As a non-limiting example, sensors can be provided in lieu of the contacts 30 for detecting the removal of a cap.

What is claimed is:

1. A bottle opener, comprising:
a housing having a handle portion;
a display provided on the housing and displaying a count;
an engaging opening provided on the housing, the opening including means for detecting the removal of a cap of a bottle; and
a processor coupled to the detecting means and the display, the processor decreasing the count by one when the detecting means detects the removal of a cap.

2. The bottle opener of claim 1, wherein the detecting means comprises a plurality of contacts.

3. The bottle opener of claim 1, wherein the detecting means comprises a sensor.

4. The bottle opener of claim 1, further including an illustration on the housing.

5. The bottle opener of claim 1, further including a speaker provided on the housing, with the processing causing the speaker to broadcast audio output when the detecting means detects the removal of a cap.

6. The bottle opener of claim 1, wherein the housing is configured as a beer bottle.

7. A method of removing a cap from a bottle, comprising the steps of:
a. providing a bottle opener, comprising:
a housing having a handle portion;
a display provided on the housing and displaying a count; and
an engaging opening provided on the housing; and
d. detecting the engagement of a cap in the engaging opening; and
e. decreasing the count by one.

8. The method of claim 7, further including:
providing a speaker on the housing; and
causing the speaker to broadcast audio output after detecting the engagement of a cap in the engaging opening.
